(19) United States
(12) Patent Application Publication
(10) Pub. No.: US 2023/0360464 A1
(43) Pub. Date: Nov. 9, 2023

(54) STAND-ALONE BULK FOOD VENDING SYSTEM

(71) Applicant: goobr LLC, Centennial, CO (US)

(72) Inventors: Daniel Katz, Centennial, CO (US); Forrest Denham, Denver, CO (US)

(21) Appl. No.: 18/195,180

(22) Filed: May 9, 2023

Related U.S. Application Data
(60) Provisional application No. 63/339,741, filed on May 9, 2022.

(51) Int. Cl. G07F 13/04; G07F 9/10; G07F 9/02; G07F 9/00

(52) U.S. Cl. CPC G07F 13/04; G07F 9/10; G07F 9/026; G07F 9/006

(57) ABSTRACT

There is disclosed a method of eliminating waste in the delivery of a metered amount of bulk food from a manufacturing outlet to a customer in a delivery area. One or more stand-alone micro-retail units may be sited at outdoor locations in the delivery area and may each comprise a weatherproof housing sheltering multiple food silos. Each food silo may store an intermediate capacity of the bulk food item and be configured to dispense the metered amount through a silo output and through a food dispenser. A refill hatch may be disposed in a wall of the housing above and for each silo, connecting to an inlet of the silo. A vending interface of the retail unit may alert the manufacturing outlet, by a level indicator, of a low storage level of the dry food item and thereby trigger a delivery of the bulk food in an intermediate bulk compartment.

### CROSS REFERENCE TO RELATED APPLICATIONS

This patent application claims priority to U.S. Provisional Application No. 63/339,741 filed on May 9, 2022 and entitled STAND-ALONE BULK FOOD VENDING SYSTEM, the entire contents of Application 63/339,741 being expressly incorporated by reference herein.

### BACKGROUND

Pet food, in particular dry dog food kibble, may be purchased in small, single-use packages at an indoor retail pet store. The 5-50 pound packages can be easily carried by one person. A traditional supply chain (FIG. 1) may involve trucking a pallet of the packages great distances to a local warehouse, a distribution center, and finally a traditional brick and mortar store where they are unloaded and manually stocked. Unfortunately, the packages may be plastic, which may be hard to recycle or ends up in a landfill or in the ocean. Also, the packages may be micro-perforated for deformable stacking on the pallet, but which may cause the food to become stale during shipping and while on the shelf. Access to pet food may be limited to retail store hours.

Bulk food stores exist in some cities, enabling customers to fill their own jars or bags with an amount of their choosing. However, access may be limited to one store in a entire metro area; customers may drive 5 miles to avoid packaging waste, but consume gasoline in the process. Further, loose fitting lids on bulk bins may permit a continuous air exchange, leading to stale food. Also, the bins may be small in order to make room for many other items like nuts, grains, and dried fruit. Therefore, price markup may be high in order to pay for frequent replenishment during each day as well as premium aisle space.

Big box stores such as Petco® may partner with a bulk food kiosk such as Canidae® to offer bulk pet food. However, product selection may be limited to two varieties, and storage volume per variety is relatively small at a couple of hundred pounds, which is reloaded using a single-use plastic bulk bag, therefore working completely against eliminating plastic waste. The products in these kiosks are also greatly exposed to the outside elements, which lead to significant risks for contamination, pest/rodent infestation, as well as additional food safety issues. Customers must also purchase specialized Canidae® packages, must weigh their product on a scale, pay for their product at a remote location, and don't have access to a quality user interface or newer generation technology.

Inexpensive outlets such as coffee huts or trailers may be stationed in parking lots, which may afford deploying a large number of these outlets in convenient locations throughout a metro area. However, the housings for these huts may require new construction materials such as lumber and steel to build, and an electric utility drop for providing electricity. Access to electricity may be limited and may reduce how many outdoor locations are available for siting the huts. Although there may be neighborhood access for the customer, the cost of employees and the new construction materials may keep customer prices as high as in a brick-and-mortar traditional coffee shop.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an embodiment, there is disclosed a method of eliminating waste in the delivery of a metered amount of a dry food item from a manufacturing outlet to a customer in a delivery area of the outlet. The method may comprise siting one or more stand-alone micro-retail units continuously accessible to the customer at outdoor locations in the delivery area. Each micro-retail unit may comprise a weatherproof housing sheltering multiple food silos. Each of the silos may be configured to store an intermediate capacity of the dry food item and may include a silo inlet and a silo outlet. The micro-retail unit may further comprise a food dispenser connectable to the silo outlet for dispensing the metered amount. A refill hatch may be provided in a housing wall for each of the silos. The silo inlet may sealably connect to the hatch positioned above the corresponding inlet. A vending interface may be disposed on the housing and may include a metering means for measuring the metered amount according to a selection of the customer

The method may further include alerting the manufacturing outlet, by a level indicator of the vending interface, of a low storage level of the dry food item. The method may further include delivering, in an intermediate bulk transport compartment and to the retail unit, a bulk supply of the dry food item, which may be freshly available at the manufacturing outlet. The method may further include conveying the bulk supply from the transport compartment through a closed mechanical or pneumatic conveyor adapted to the refill hatch. The method may further include dispensing and metering the selected dry food item from the food dispenser into a customer-provided package. The bulk supply delivery and the dry food dispensing may together eliminate single-use packaging waste common to distribution and retail operations.

In a further embodiment, there is disclosed a stand-alone micro-retail unit for a bulk food vending system. The bulk vending system may be configured to provide, from a manufacturing outlet, a metered amount of a dry food item to a retail customer. The manufacturing outlet may provide the metered amount through a network of the micro-retail units in a delivery area of the manufacturing outlet.

Each micro-retail unit may comprise a weatherproof housing having a dispensing end and a refilling end opposite the dispensing end. The retail unit may be configured for an outdoor location in the delivery area. Multiple food silos may be disposed within the weatherproof housing for storing the dry food item, where each food silo may have a silo inlet and a silo outlet configured to dispense old food first. A refill hatch for each of the multiple food silos may be disposed on the refilling end of the housing and positioned above the silo inlet. The hatch may be sealably connected to the silo inlet when the hatch is closed, and may be configured to receive a bulk delivery of the dry food item when the hatch is open. The bulk delivery may arrive directly at the hatch from an intermediate bulk transport compartment delivered to the outdoor location.

Each micro-retail unit may further include a food dispenser on the dispensing end of the housing and connected to the silo outlet. The dispenser may be configured to transfer the dry food item to a customer-provided package. A vending interface may be positioned on the housing and may include a payment system for selling the metered amount. The vending interface may also include a signaling means for alerting the manufacturing outlet of a low storage level of the dry food. The vending interface may also include a metering means for measuring the metered amount according to a selection of the customer. The customer may pay for the selected metered amount through the payment system. The bulk delivery and the dry food dispensing may eliminate single-use packaging waste.

In still another embodiment, there is provided a stand-alone micro-retail unit for a bulk food vending system providing a metered amount of a dry food item to a retail customer in a delivery area of the manufacturing outlet.

Each micro-retail unit may include a housing having a dispensing end and a refilling end opposite the dispensing end and configured for the delivery area. At least one food silo may be provided within the housing for storing the dry food item, each food silo having a silo inlet and a silo outlet configured to dispense old food first. A refill hatch may be provided on the refilling end of the housing and sealably connected to the silo inlet when the hatch is closed, the hatch positioned above the inlet and configured to receive a bulk delivery of the dry food item when the hatch is open and from an intermediate bulk transport compartment delivered to the outdoor location. A food dispenser may be provided on the dispensing end of the housing and connectable to the silo outlet for transferring the dry food item to a customer-provided package. A vending interface may be provided on the housing and including a payment system for selling the metered amount, a signaling means for alerting the manufacturing outlet of a low storage level of the dry food, and a metering means for measuring the metered amount according to a selection of the customer. A dispensing auger may be provided for transferring the selected dry food item from the silo outlet to the food dispenser, where the metering means is counting a number of rotations of the auger during the dispensing, and where the metered amount is a calculated weight based on measuring a duration of the dispensing. In an embodiment, the customer pays for the selected metered amount through the payment system, and the bulk delivery and the dry food dispensing eliminates single-use packaging waste.

Additional objects, advantages and novel features of the technology will be set forth in part in the description which follows, and in part will become more apparent to those skilled in the art upon examination of the following, or may be learned from practice of the technology.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified. Illustrative embodiments of the invention are illustrated in the drawings, in which:

FIG. 1 illustrates a prior art supply chain for dry pet food packaged in 5-50 pound bags.

FIG. 2 illustrates a block diagram of a bulk food vending system including multiple micro-retail units, in accordance with an embodiment of the present disclosure.

FIG. 3 illustrates a perspective drawing of dispenser chutes on an exterior of the micro-retail unit, in accordance with an embodiment of the present disclosure.

FIG. 4 illustrates a perspective drawing of an interior of the micro-retail unit, in accordance with an embodiment of the present disclosure.

FIG. 5 illustrates a perspective drawing of a repurposed shipping container for the micro-retail unit, in accordance with an embodiment of the present disclosure.

FIG. 6 illustrates block diagram of an auger and other components inside the micro-retail unit, in accordance with an embodiment of the present disclosure.

FIG. 7 illustrates a perspective drawing of an intermediate bulk container (IBC) for replenishing the micro-retail unit, in accordance with an embodiment of the present disclosure.

FIG. 8 illustrates a block diagram for automatically conveying an intermediate bulk supply for the micro-retail unit, in accordance with an embodiment of the present disclosure.

FIG. 9 illustrates a customer flowchart for interacting with the micro-retail unit, in accordance with an embodiment of the present disclosure.

FIG. 10 illustrates a diagram for a pneumatic transfer system within the micro-retail unit, in accordance with an embodiment of the present disclosure.

FIG. 11 illustrates a lower portion of the pneumatic transfer system within the micro-retail unit, in accordance with an embodiment of the present disclosure.

FIG. 12 illustrates a perspective drawing of dispenser wands on the exterior of the micro-retail unit, in accordance with an embodiment of the present disclosure.

FIGS. 13a-13b illustrate a drawing of a handle and mount for the dispenser wand of the micro-retail unit, in accordance with an embodiment of the present disclosure.

FIG. 14 illustrates a drawing of a vending interface and controller for the micro-retail unit, in accordance with an embodiment of the present disclosure.

### DETAILED DESCRIPTION

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

As may be appreciated, based on the disclosure, there exists a need in the art for an inexpensive and 24/7 neighborhood source of bulk pet food dispensable into a reusable package owned by a retail customer. Also, there exists a need in the art for protecting the bulk food from air exchange once it's manufactured in order to keep the food fresh. Additionally, there exists a need in the art to reduce single-use packaging during shipping from a manufacturing outlet. Further, there exists a need in the art for larger bulk storage containers that reduce the labor of daily replenishment, and a need for off-grid housing of the bulk storage for quicker deployment in any outdoor location.

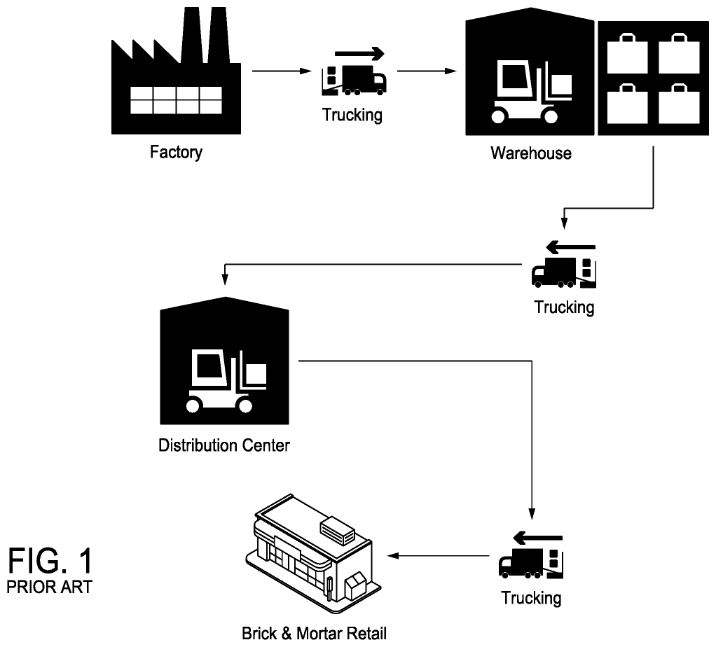

Referring to FIG. 1, in the prior art, a traditional supply chain may deliver pet food for sale at brick-and-mortar outlets in 5-50-lb. (‘kid-sized’) packages, described further in the Background section of this document.

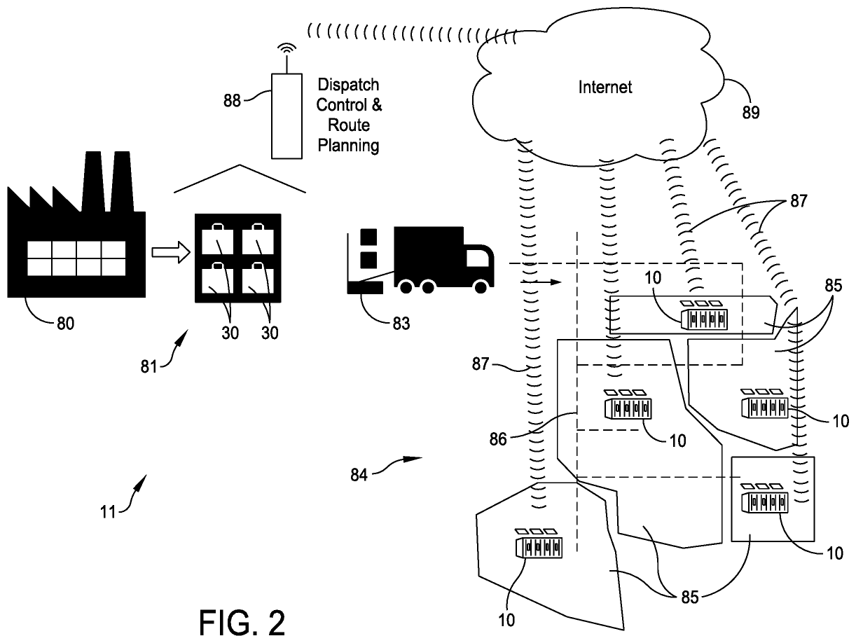

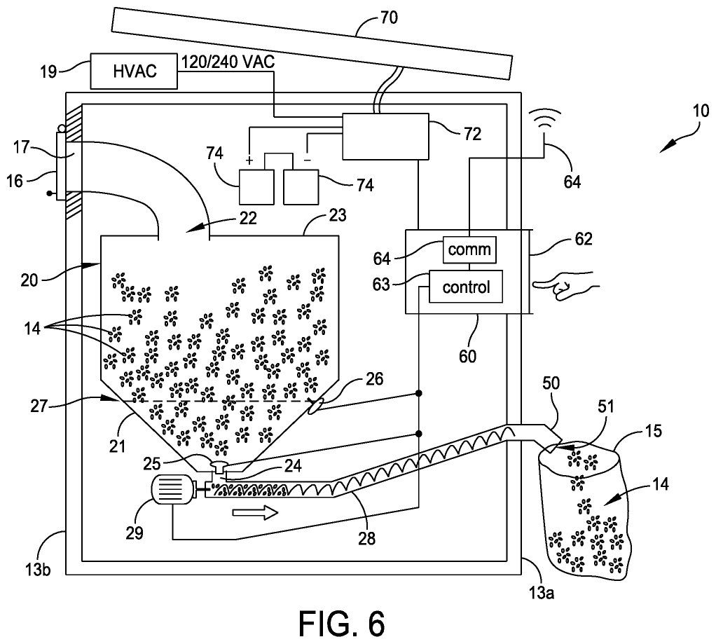

Referring to FIGS. 2-7, in various embodiments, a method and system are described for eliminating packaging waste in the delivery of a metered amount of a dry food item 14 to a customer-provided package 15 of the customer (FIG. 6). The customer-provided package 15 may preferably be a reusable package. The method may include a manufacturing outlet 80 having a back end factory for completing a production of the dry food item 14 within a delivery area 84 of the customer. One or more stand-alone micro-retail units 10 may be sited at outdoor locations in the delivery area 84 for dispensing the metered amount. The dry food item 14 may be one or more of dog food kibble, pet food, and one or more of the following human-grade foods: beans, grains, nuts, seeds, trail mix, and dried fruit. A preferred embodiment of this disclosure is the dispensing of bulk dog food. For ease, the following discussion refers generally to “bulk food” or “dry food”.

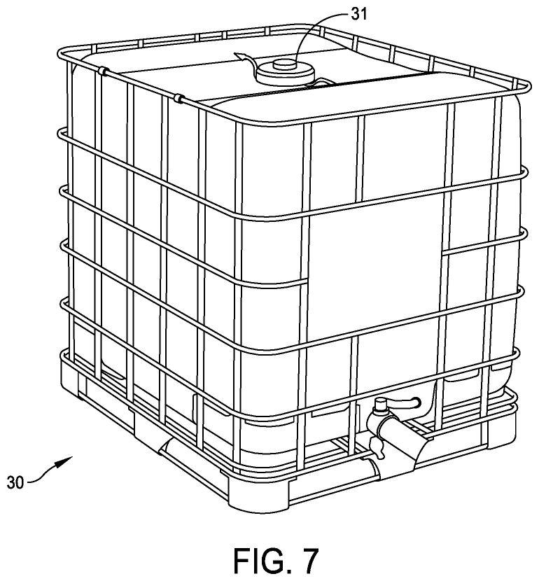

Continuing, in various embodiments, a bulk supply of the dry food item 14 available at the manufacturing outlet 80 may be delivered 83 to the micro-retail unit 10 in an intermediate bulk transport compartment 30. For example, the bulk supply may be delivered 83 to the micro-retail unit 10 in a reusable IBC (intermediate bulk container) tote 30 (FIGS. 2 and 7) providing a large volume of the dry food without the use of packaging. In a preferred embodiment, the method may include loading the bulk supply from the back end factory directly into the intermediate transport compartment and without an intervening storage or warehouse step. A capacity of the IBC tote 30 may be 275 gallons, or more, and may thereby hold 1500 pounds or more of pet food kibble 14, equivalent to sixty retail packages of pet food at 25 pounds each. Advantageously, the IBC tote 30 may be reusable and may keep the food 14 fresher than the microperforated bags used in the prior art (FIG. 1). Alternatively, an intermediate-sized bulk supply of the dry food item may be delivered along routes 86 in a compartment (not shown) of a delivery truck 83 servicing the delivery area 84.

Referring to FIGS. 2-6, in various embodiments, the micro-retail unit 10 may comprise a weatherproof housing 12 sheltering multiple food silos 20 for storing an intermediate capacity of the dry food item 14. Each of the silos 20 may have a silo inlet 22 for receiving the bulk supply at a refilling end 13b (a back wall) of the housing 12. Each silo 20 may also be configured to dispense old food first through a silo outlet 24 connectable to a dispensing end 13a (a front wall) of the housing 12. The retail unit 10 may be configured for siting at an outdoor location in the delivery area 84, preferably in a neighborhood 85 of the customer and continuously accessible for 24/7 access. A portion of a parking lot or other real estate may be assigned for use by the micro-retail unit 10. A bottom of the housing 12 may be configured to rest on a grass or a concrete lot in a way that is structurally sound and weatherproof.

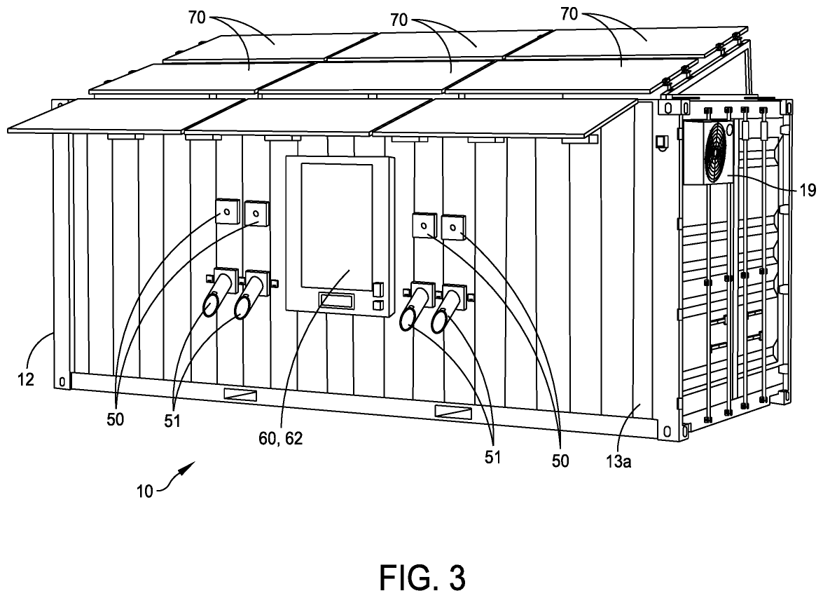

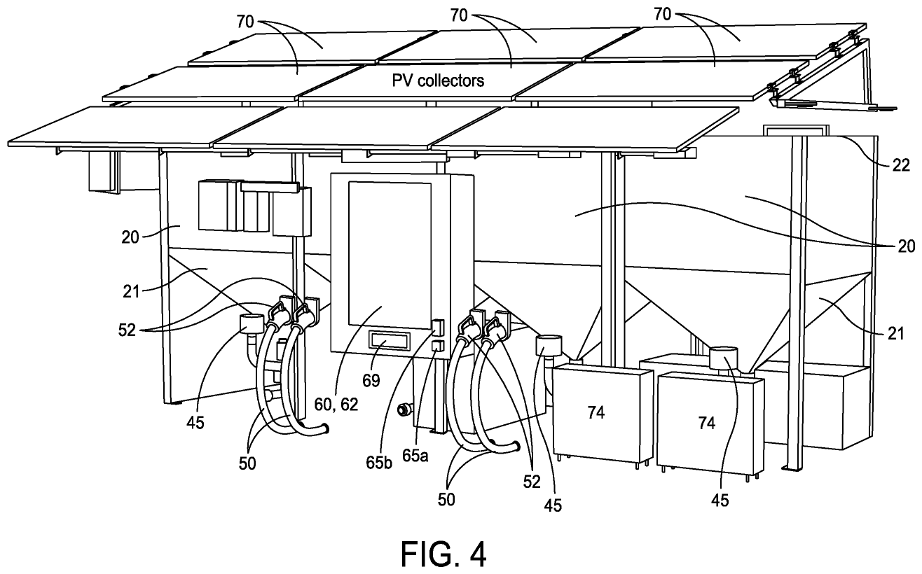

Continuing with FIGS. 2-6, the micro-retail unit 10 may include a food dispenser 50 on dispensing end 13a of the housing 12 for providing the dry food item 14 to the customer-provided package 15. A transfer line 28 may connect the food dispenser 50 to the silo outlet 24, and may be an apparatus for mechanically transferring the selected dry food item to the food dispenser 50 using an auger or a pneumatic means (described below). Dispensing end 13a may be disposed with one or more dispensers 50 for directing the dry food item 14 into the reusable package 15. In an embodiment shown in FIGS. 4 and 12-13, four dispenser wands 50 may include a flexible portion for pointing a dispenser outlet 51 into the reusable package 15 using a handle 52. In another embodiment shown in FIG. 3 dispenser 50 may be a chute with outlet 51 for filling customer package 15. More or fewer dispensers 50 may be disposed on the dispensing end 13a, depending on the number of food silos 20 in housing 12.

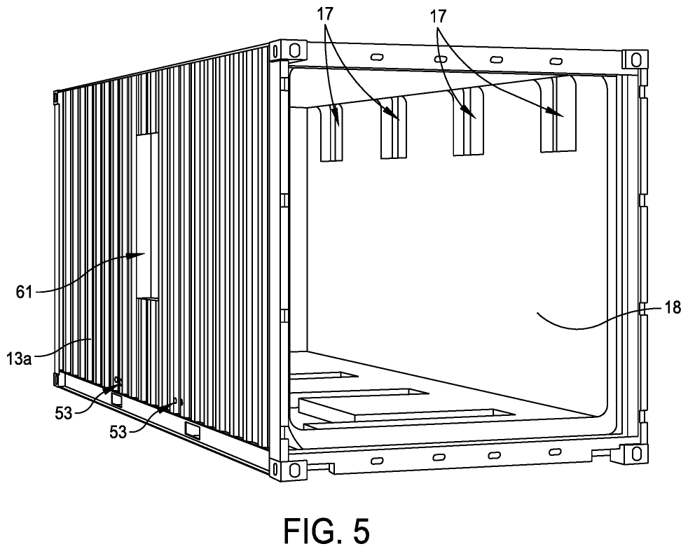

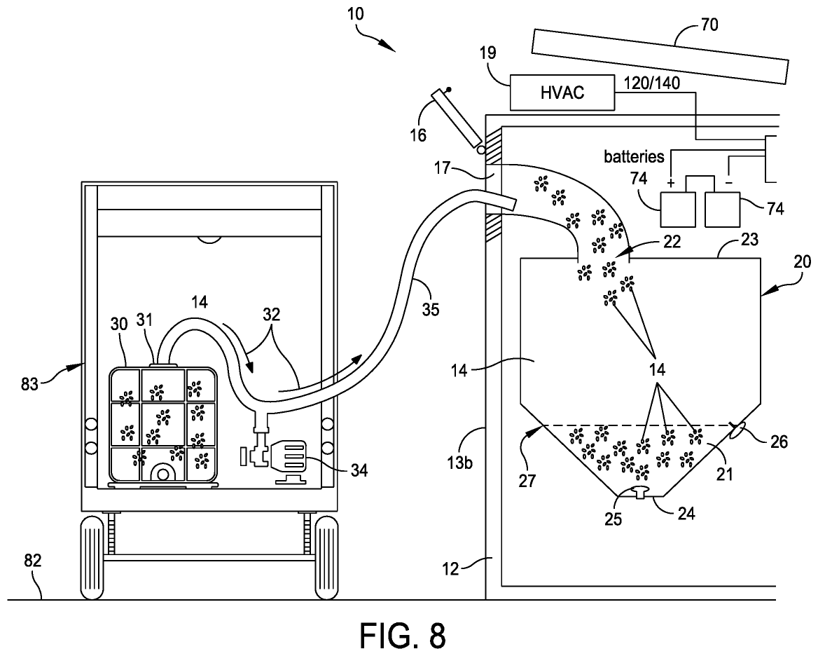

Referring to FIGS. 2-8 now, the micro-retail unit 10 may include a refill hatch 16 for sealing a hatch passageway 17 (FIG. 5) through the refilling end 13b of the housing 12. Preferably, a hatch 16 may be provided for each of the silos 20. The hatch 16 may sealably connect to the silo inlet 22 when the hatch 16 is closed for maintaining a freshness of the dry food 14. The hatch may be positioned above the inlet 22 and configured to receive a bulk delivery of the dry food item 14 from an intermediate bulk transport compartment 30. For example, the bulk food vending system 11 may include a closed mechanical or pneumatic conveyor 32 (FIG. 8) for conveying the bulk supply of the dry food item 14 from the intermediate transport compartment 30 through the conveyor 32 adapted to the refill hatch 16. This will be discussed in more detail below.

Continuing further with FIGS. 2-6, in various embodiments, the weatherproof housing 12 may be a repurposed housing for reducing a consumption of new construction materials and the resultant waste. In particular, the weatherproof housing 12 may be a repurposed shipping container for reducing the consumption of new construction materials. Alternatively, other used structures may be repurposed for a micro-retail system 10, such as a wooden shed, a mobile trailer, or other pre-owned structure.

Continuing, the shipping container may be modified (repurposed) to suit the requirements of the stand-alone micro-retail unit 10. Shipping containers may be plentiful, designed for outdoor environments, structurally sound, inexpensive, about 8 feet wide, and typically about 10-40 feet in length. Repurposing the shipping container may require cutting out one or more of a hatch passage 17 for the hatch 16, a vending cutout 61 for vending interface 60, and a dispenser cutout 53 for connecting the transfer line 28 (FIG. 6) from the silo outlet 24 to the food dispenser 50. Adding insulation 18 to interior walls of the housing 12 and an HVAC unit 19 may provide the stand-alone qualities of being independent from another retail structure for electricity and hygrothermic regulation.

Referring to FIGS. 3-4, 6, 8, 10, and 12, in an embodiment, the micro-retail unit 10 may be powered by an off-grid power system positioned on or near the weatherproof housing for providing the electricity. Beneficially, adding the off-grid power and hygrothermic regulation 19 to the micro-retail units 10 may provide greater flexibility in siting and less real estate expense. In a preferred embodiment, the method may include supplying the electricity needs with one or more photovoltaic (solar) panels 70 proximate the weatherproof housing 12. The solar panels 70 may feed electrical storage batteries 74 for storing solar energy, and the batteries 74 may feed an inverter and charge controller 72 for providing alternating current and regulating the battery charging, respectively.

Alternatively, wind, biomass, and other forms of renewable energy may also supply electrical power to the vending system 11 independent of the utility grid. In a preferred embodiment, solar panels 70 may be mounted to a roof of the repurposed shipping container.

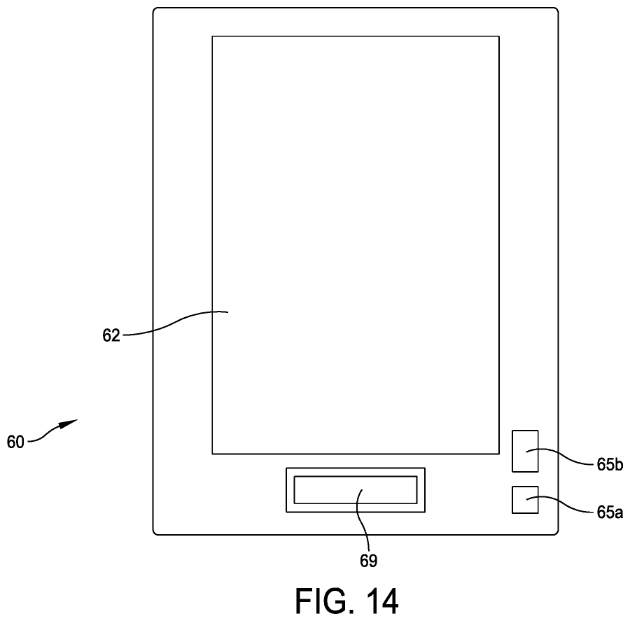

Referring now to FIGS. 2-6, and 14, in various embodiments, the micro-retail unit 10 may include a vending interface 60 including a controller 63 and disposed on the housing 12, preferably for presenting a touch screen or user panel 62 to the customer on the dispensing end 13a. The vending interface 60 may include a metering means for measuring the metered amount according to a selection of the customer, and may include a payment system for paying for the metered amount. The vending interface 60 and controller 63 may include a signaling means for alerting the manufacturing outlet 80 of a low storage level 27 of the dry food and/or request a delivery of the bulk supply. In one embodiment, the vending interface 60 may include a communications module 64 for providing the signaling means alerting a dispatch control and route planning module 88 at the manufacturing outlet 80 (FIG. 2).

Continuing, the dispatch control 88 (FIG. 2) may receive information from the network of the micro-retail units 10 via communication links 87 communicating which food silos 20 needing replenishment. The bulk supply may be delivered by routes 86 from the refill vehicle 83. In one embodiment communication links 87 may arrive via the internet 89. However, the links 87 may also arrive via a landline link or cellular messaging. Similarly, the communications module 64 at the micro-retail unit 10 may operate via a cellular, WiFi, CATV, or a landline link. The payment system may include configuring the communications module 64 to connect with one or more financial institutions for the processing of customer payment.

Continuing with FIGS. 2-6, and 14, in various embodiments, the silo outlet 24 may be sealed by an outlet gate 25 when dry food 14 is not being dispensed. Such sealing by outlet gate 25 may include retaining a fluid or a gas under atmospheric pressure when the gate is closed. The gate 25 may be controlled by the vending interface 60 and controller 63 according to the customer selection. The food silo 20 may include a level indicator 26 for sensing an amount of dry food 14 remaining in the silo 20. Vending interface 60 and controller 63 may connect to the level indicator 26 for detecting the low storage level 27.

Further, the metering means may utilize one or more of the level indicator 26 for each of the multiple silos 20, a dispensing scale (not shown) for weighing the metered amount, and a flow meter on the transfer line 28 connecting the silo outlet 24 and the food dispenser 50. The transfer line 28, in one embodiment, may be a dispensing auger for transferring the selected dry food item 14 from the silo outlet 24 to the food dispenser 50, where the metering means is counting, by the vending interface 60, a number of rotations of the auger 28 during the dispensing, and where the metered amount is a calculated weight based on measuring a duration of the dispensing. Counting the rotations and duration may constitute the flow meter for metering the dry food item 14 while dispensing. The dispensing auger 28 may be a flexible or rigid tube for moving dry food horizontally and uphill to the dispenser outlet 51 driven by auger motor 29 and controllable by vending interface 60 and controller 63.

In further embodiments, continuing with FIGS. 2-6, and 14, a kind of flow meter may determine an amount to charge based on an open time of the outlet gate 25 during the dispensing of the dry food item 14 to the customer. By calibrating an outflow rate per unit time for the food silo, the metered amount of the dry food item 14 may be calculated and a charge presented to the customer by the vending interface 60. If operable and accurate over a wide range of storage levels 27, then, alternatively, the level indicator 26 may be sensed before and after dispensing the dry food item 14 in order to determine the metered amount. In another embodiment, the metered amounts from a sequence of dispensing transactions may be accumulated to estimate an occurrence of the low storage level 27. The dispensing scale may be a weighing mechanisms (not shown) coupled to each silo 20 and the vending interface 60, or may be a flat scale under the customer-provided package 15 and connected to the interface 60.

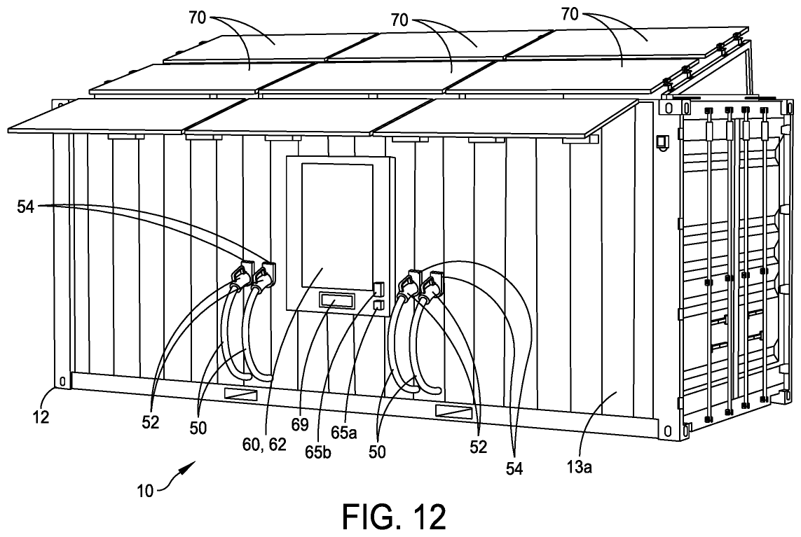

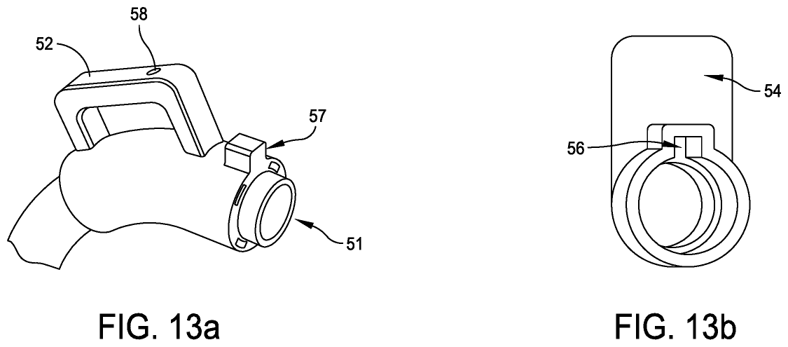

Referring now to FIGS. 3-4, 6, 12, and 13a-13b, in various embodiments, the dispenser 50 may include a customer trigger 58 (FIG. 13a) on the handle 52 for one-handed control of the dispensing process. (The other hand may hold the reusable package.) The vending interface 60, once the customer selection has been made, may turn on the auger motor 29 and open the outlet gate 25 to initiate a flow of the dry food item (FIG. 6). Alternatively, or in the case of the chute dispensers 50 of FIG. 3, the trigger 58 may be positioned on the dispensing end 13a of the housing 12, on the user panel 62, or on an micro-retail application of the user's smart phone. The outlet gate 25 may be a ball valve whose means of actuation by the controller 63 is one of pneumatic, electrical, and mechanical. A handle mount 54 may be disposed on the dispensing end 13a of the housing 12 and may include a mount latch 56 (FIGS. 12 and 13b) that holds the dispenser handle 52 when the dispenser 50 is not in use.

Continuing, when the customer has filled their reusable package 15, they may release the trigger 58 which may close the outlet gate 25. The auger transfer line 28, or alternative mechanical or pneumatic transfer means, may be allowed to run for a few more seconds to clear out the transfer line. In alternative embodiments different from the dispensing wand 50, the dispenser outlet 51 (not shown) may be an opening in the dispensing end 13a of the housing, similar to conventional bulk food bins, and the customer trigger 58 may be a sliding door normally covering the opening. The customer trigger 58 may alternatively be a locking mechanism that enables the sliding door to be opened.

Considering now FIGS. 5-8, in various embodiments, the silo inlet 22 may be environmentally sealed when the refill hatch 16 is closed. For example, the refill hatches 16 may be outfitted with gasketed doors. An airtight channel or hose may be fitted to connect the silo inlet 22 to the hatch opening 17. Through sealing both the silo inlet 22 and the silo outlet 24 via the outlet gate 25, the dry food 14 may keep maximally fresh.

Continuing, once the storage level for one or more of the food silos 20 has fallen below a refill threshold, the bulk supply may be delivered to the outdoor location 82 for replenishing the food silo 20 exhibiting the low storage level 27. The delivery truck 83 (FIG. 8) may be a box truck and may be configured with a pneumatic means, an auger system, or other mechanical conveyor for automatically transferring up to 1500 pounds or more of kibble from an IBC tote 30. In a preferred embodiment, a capacity of the food silo 20 approximately matches a capacity of the intermediate transport compartment 30 for completing the replenishing without changing IBC totes 30. For example, by roughly matching the capacity of the 1500-pound IBC tote 30 to the capacity of the food silo 20, a transfer time may be minimized with little or no dry food left in the IBC tote 30.

Referring to FIG. 8, in one embodiment, the refill hatch 16 may be configured for automatically receiving the bulk delivery from the intermediate transport compartment 30 through a pneumatic conveyor 32. A conveyance hose 35 may be pressurized with a pneumatic pump 34 shown between the IBC tote 30 and the refill hatch 16. Since the IBC inlet 31 may be around 6 inches in diameter, a diameter of the conveyance hose may be 3-4 inches, or slightly larger. Alternatively, the pump 34 may be arranged to be upstream of the IBC tote 30, or may be placed at some middle position other than the one shown in FIG. 8. The level indicator 26 of the corresponding food silo 20, or some other measure of fullness accessible to a driver of the delivery vehicle or staff, may automatically or manually turn off pump 34 once the food silo 20 is full.

Continuing, in another embodiment not shown, a flexible auger may operate to automatically convey the bulk supply through the auger hose 35 and be driven by an auger motor powered by the delivery truck 83 or by the micro-retail unit 10. Other closed mechanical conveyors known in the art may also be employed which are operable to move dry bulk food from the IBC tote 30 and through the flexible hose 35. In another embodiment, the intermediate transport compartment 30 may be elevated above the refill hatch 16 to provide a closed gravity conveyance through a rigid or flexible channel. For example, the delivery truck 83 may include a hydraulic lift to elevate the intermediate transport compartment 30 above the elevation of the refill hatch 16.

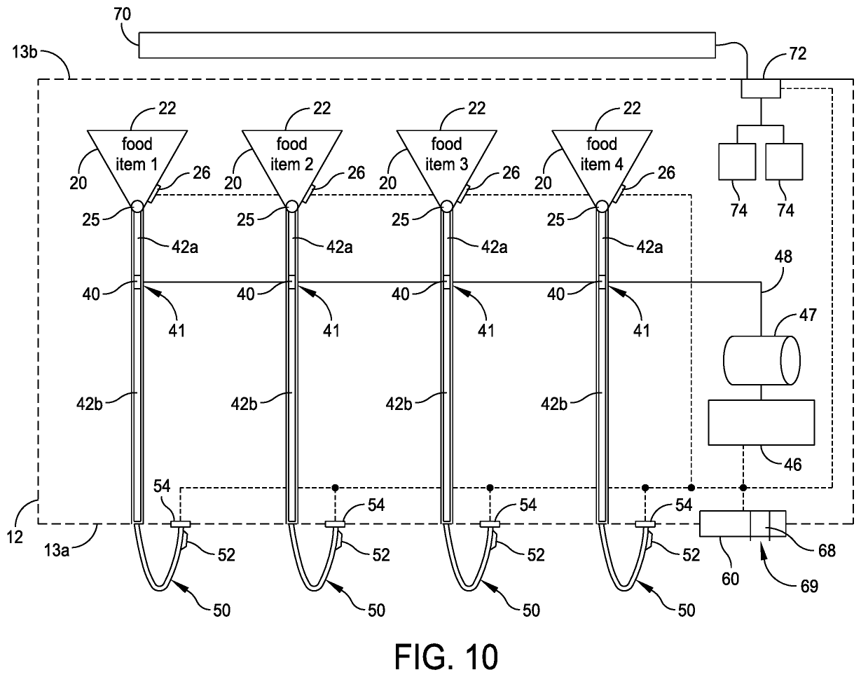

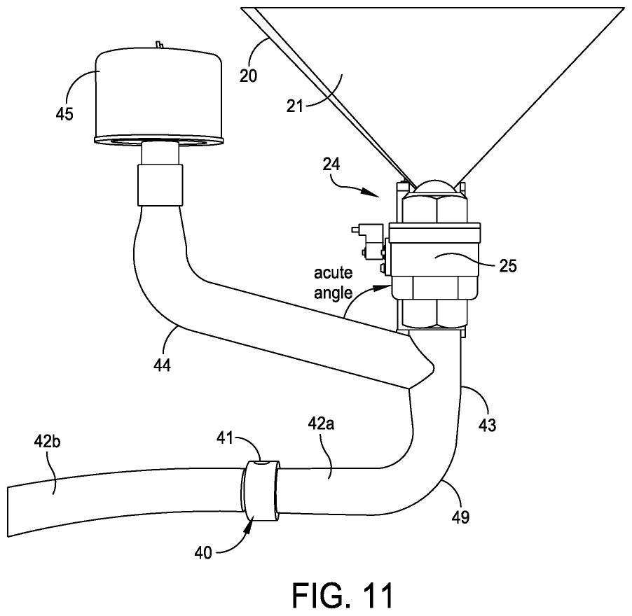

Referring now to FIGS. 10-13b, in another embodiment of the transfer line 28, the pneumatic means for transferring the dry food item 14 from the silo outlet 24 is described. The pneumatic means may include a pneumatic pump 40 disposed between a vacuum-side transfer line 42a and a pressure-side transfer line 42b for connecting a downpipe 43 of the silo outlet 24 to the food dispenser 50. An injection port 41 of the pneumatic pump may receive compressed air from compressor 46 feeding air tank 47 through compressor hose 48 when the compressor hose 48 is pressurized for causing a transfer of the dry food item 14. In a preferred embodiment, the outlet gate 25 may be a pneumatic ball valve for sealing in a partial vacuum within the food silo 20 when the gate 25 is closed and the pump is off.

Continuing with FIGS. 10-13b, an air intake pipe 44, including an air filter 45 on an upper end of pipe 44, may intersect the downpipe 43 at a lower end in order to feed air through the transfer line 42a and may therefore reduce air being pulled through the food silo 20 when the outlet gate 25 is open. In a preferred embodiment, the air intake pipe 44 may intersect the vertical section of the downpipe 43 at an acute angle in order to accelerate the downward flow of dry food and avoid clogging at an otherwise perpendicular corner.

Relays (not shown) in the compressor hose (or hoses) 48 may be actuated by the vending interface 60 and controller 63 for switchably controlling which injection port 41 is fed compressed air, thereby enabling only the dry food type (1, 2, 3, or 4) selected by the customer. Downpipe 43 may include a diametric constriction 49 located between an intake intersection and the pneumatic pump 40 in order to accelerate a flow of air after engaging the pneumatic conveyor and before opening the outlet gate 25. A diameter of the constriction may be about 2.5″ when a diameter of the downpipe is about 3″.

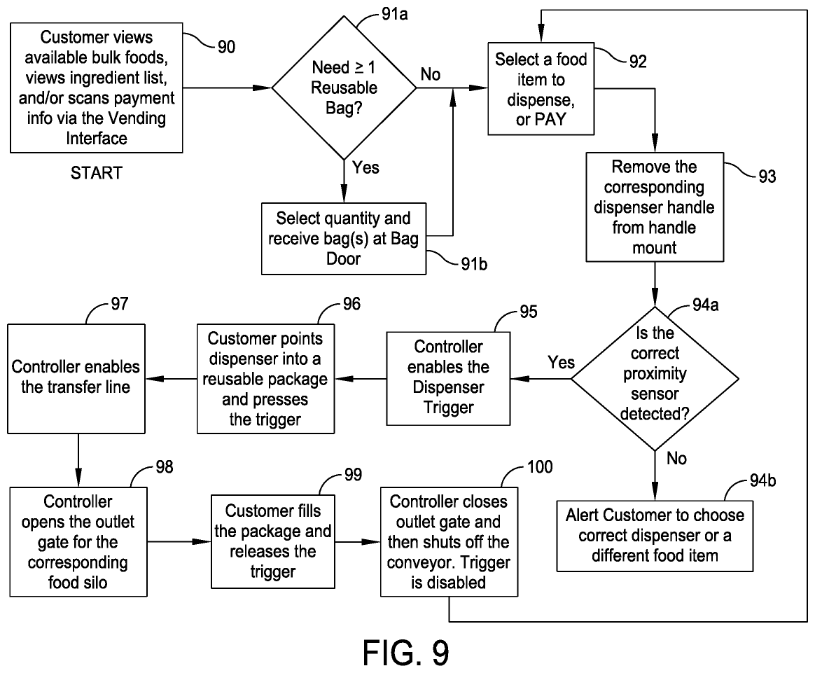

Referring now to FIGS. 9-14, in an embodiment, a customer vending sequence is described (FIG. 9). The customer may approach 90 the vending interface 60 and/or user panel 62 and may view the available dry food items 14, including an ingredients list. The vending interface 60 may include a QR scanner 65b for scanning a QR code on the customer's smart phone and identifying a customer account, entering payment information, and/or making product selections. The bulk food vending system 11 may include a downloadable mobile application (not shown) coordinating with the vending interface 60 and controller 63 for selecting food items to dispense and to pay for the metered amount. QR codes (not shown) may also be posted near each food dispenser 50 for selecting a dry food item 14 using the mobile application. The mobile application may link a customer's virtual wallet to the vendor interface 60 for payment.

The customer may be given an option 91a to purchase one or more reusable vended bags (not shown) in case they neglected to provide one. The vending interface 60 may include a bag chamber 68 for storing and selling the reusable bags to the customer. A bag dispensing door 69 may be connected to the bag chamber 68 for dispensing the reusable bags. The bags may be stocked as folded up squares for the purpose of fitting inside the bag chamber 68. Each bag may zip into itself to form a smooth exterior without loose flaps or edges and without strings that would become tangled with other packages in the bag chamber 68. Once purchased and received 91b, the customer may unfold it into a large resealable bag that can be filled with dog food or other dry food items. The reusable bag may also contain a pocket on the inside for storing a scoop for conveniently serving the dry food item.

Continuing still with FIGS. 9-14, the customer may select 92 a dry food item and remove 93 the corresponding food dispenser 50 from its mount 54. The handle mount 54 may include a mount sensor 57 (FIG. 13a) for detecting 94a a removal of the handle 52 and which may signal the controller 62 to enable the corresponding customer trigger 58. If an incorrect dispenser 50 is detected 94b being removed from its mount 54, the customer may be directed to the correct dispenser 50, whereupon the trigger 58 may be enabled 95. The mount sensor 57 may be a proximity sensor with complimentary components on each of the handle 52 and the handle mount 54. In particular, the proximity sensor 57 may be a magnetic reed design. In another embodiment, the mount latch 56 may be a magnetic latch with complimentary components on each of the handle 52 and the mount 54.

Continuing further, next, the customer may point the dispenser outlet 51 into the customer-provided package 15 and press 96 the dispenser trigger 58. The controller 63 may then enable 97 the transfer line 28/42. Once the flow of the dry food item 14 is established, the outlet gate 25 may be opened 98 by the controller 63 for the corresponding food silo 20. When the customer has filled their reusable package 15, they may release 99 the trigger 58 which may close and seal the outlet gate 25. Shortly thereafter, the transfer line 28/42 may be disabled 100 once any remaining dry food 14 in the transfer line has been cleared.

Referring again to FIGS. 2-8, the food silos 20 may be constructed of food grade stainless steel (304 stainless steel) and may also be called ‘dump stations’. Alternatively, the silos 20 may be constructed of plastic, rubber, or other metals that can hold an environmental seal and remain inert and rust free when in contact with bulk food items that may contain some moisture. A bottom 21 of each silo 20 may be conical, or may narrow pyramidally toward the silo outlet 24 for providing a first-in-first-out food function.

Although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

What is claimed is:

1. A method of eliminating waste in the delivery of a metered amount of a dry food item from a manufacturing outlet to a customer in a delivery area of the outlet, the method comprising:
siting one or more stand-alone micro-retail units continuously accessible to the customer at outdoor locations in the delivery area, each micro-retail unit comprising:
a weatherproof housing sheltering multiple food silos for storing an intermediate capacity of the dry food item, each silo having a silo inlet and a silo outlet;
a food dispenser connectable to the silo outlet for dispensing the metered amount;
a refill hatch in a housing wall for each of the silos, the silo inlet sealably connected to the hatch positioned above the corresponding inlet; and
a vending interface on the housing and including a metering means for measuring the metered amount according to a selection of the customer; and
alerting the manufacturing outlet, by a level indicator of the vending interface, of a low storage level of the dry food item;
delivering, in an intermediate bulk transport compartment and to the retail unit, a bulk supply of the dry food item freshly available at the manufacturing outlet;
conveying the bulk supply from the transport compartment through a closed mechanical or pneumatic conveyor adapted to the refill hatch;
dispensing and metering the selected dry food item from the food dispenser into a customer-provided package; and
where the bulk supply delivery and the dry food dispensing eliminate single-use packaging waste common to distribution and retail operations.

2. The method of claim 1, further comprising:
paying for the metered amount through the vending interface.

3. The method of claim 2, further comprising:
linking the vending interface to a cloud-based application for the paying.

4. The method of claim 1, wherein:
the weatherproof housing is a repurposed shipping container for reducing waste in construction materials.

5. The method of claim 1, wherein:
the manufacturing outlet includes a back end factory for completing a production of the dry food item for maximizing a freshness of the dry food.

6. The method of claim 5, further comprising:
loading the bulk supply from the back end factory directly into the intermediate transport compartment.

7. The method of claim 1, wherein:
the intermediate bulk transport compartment is a reusable IBC tote or a compartment in a delivery truck servicing the delivery area.

8. The method of claim 1, wherein:
the dry food is pet food kibble.

9. The method of claim 1, further comprising:
supplying electricity needs of the stand-alone micro-retail unit with a photovoltaic system proximate the weatherproof housing.

10. The method of claim 1, further comprising:
mechanically transferring the selected dry food item from the silo outlet to the food dispenser using an auger or a pneumatic means.

11. The method of claim 1, wherein:
the metering means utilizes one or more of the level indicator for each of the multiple silos, a dispensing scale for weighing the metered amount, and a flow meter on a transfer line between the silo outlet and the food dispenser.

12. A stand-alone micro-retail unit for a bulk food vending system providing, from a manufacturing outlet and through a network of the micro-retail units, a metered amount of a dry food item to a retail customer in a delivery area of the manufacturing outlet, each micro-retail unit comprising:
a weatherproof housing having a dispensing end and a refilling end opposite the dispensing end and configured for an outdoor location in the delivery area;
multiple food silos within the weatherproof housing for storing the dry food item, each food silo having a silo inlet and a silo outlet configured to dispense old food first;
a refill hatch on the refilling end of the housing and sealably connected to the silo inlet when the hatch is closed, the hatch positioned above the inlet and configured to receive a bulk delivery of the dry food item when the hatch is open and from an intermediate bulk transport compartment delivered to the outdoor location;
a food dispenser on the dispensing end of the housing and connectable to the silo outlet for transferring the dry food item to a customer-provided package;
a vending interface on the housing and including a payment system for selling the metered amount, a signaling means for alerting the manufacturing outlet of a low storage level of the dry food, and a metering means for measuring the metered amount according to a selection of the customer; and
where the customer pays for the selected metered amount through the payment system, and where the bulk delivery and the dry food dispensing eliminate single-use packaging waste.

13. The micro-retail unit of claim 12, further comprising:
a dispensing auger for transferring the selected dry food item from the silo outlet to the food dispenser, where the metering means is counting a number of rotations of the auger during the dispensing, and where the metered amount is a calculated weight based on measuring a duration of the dispensing.

14. The micro-retail unit of claim 12, wherein:
the intermediate transport compartment is an IBC (intermediate bulk container) tote or a compartment in a delivery truck supplying the delivery area.

15. The micro-retail unit of claim 12, wherein:
the bulk delivery from the transport compartment is automated through a closed mechanical or pneumatic conveyor adapted to the refill hatch.

16. The micro-retail unit of claim 12, further comprising:
a level indicator connectable to each of the multiple food silos for indicating the low storage level.

17. The micro-retail unit of claim 12, wherein:
the signaling means is a cellular, WiFi, CATV, or landline link.

18. The micro-retail unit of claim 12, further comprising:
a chamber in the vending interface for vending a reusable pet food package to the customer for receiving the dry food item.

19. The micro-retail unit of claim 12, wherein:
a capacity of the food silo approximately matches a capacity of the transport compartment.

20. A stand-alone micro-retail unit for a bulk food vending system providing a metered amount of a dry food item to a retail customer in a delivery area of the manufacturing outlet, each micro-retail unit comprising:
a housing having a dispensing end and a refilling end opposite the dispensing end and configured for the delivery area;
at least one food silo within the housing for storing the dry food item, each food silo having a silo inlet and a silo outlet configured to dispense old food first;
a refill hatch on the refilling end of the housing and sealably connected to the silo inlet when the hatch is closed, the hatch positioned above the inlet and configured to receive a bulk delivery of the dry food item when the hatch is open and from an intermediate bulk transport compartment delivered to the outdoor location;
a food dispenser on the dispensing end of the housing and connectable to the silo outlet for transferring the dry food item to a customer-provided package;
a vending interface on the housing and including a payment system for selling the metered amount, a signaling means for alerting the manufacturing outlet of a low storage level of the dry food, and a metering means for measuring the metered amount according to a selection of the customer;
a dispensing auger for transferring the selected dry food item from the silo outlet to the food dispenser, where the metering means is counting a number of rotations of the auger during the dispensing, and where the metered amount is a calculated weight based on measuring a duration of the dispensing; and
where the customer pays for the selected metered amount through the payment system, and where the bulk delivery and the dry food dispensing eliminate single-use packaging waste.
